(19) United States
(12) Patent Application Publication
(10) Pub. No.: US 2014/0021927 A1
(43) Pub. Date: Jan. 23, 2014

(54) ADAPTIVE CURRENT CONTROL FOR INDUCTIVE LOADS

(71) Applicants: Robert D. Klapatch, Wethersfield, CT (US); William E. Villano, Canton, CT (US)

(72) Inventors: Robert D. Klapatch, Wethersfield, CT (US); William E. Villano, Canton, CT (US)

(73) Assignee: HAMILTON SUNDSTRAND CORPORATION, Windsor Locks, CT (US)

(21) Appl. No.: 13/553,121

(22) Filed: Jul. 19, 2012

(51) Int. Cl. G05F 1/10

(52) U.S. Cl. 323/271

(57) ABSTRACT

A current control system for controlling current provided to a load includes a current sensor that senses a current to the load; a first power switch selectively enabled to supply power to the load and disabled to prevent power from being supplied to the load; and a control circuit. The control circuit includes a comparator that compares the sensed current with a commanded current to determine whether to enable or disable the first power switch, and a timer circuit that prevents the power switch from being enabled by the comparator more than once within a predetermined time period.

### BACKGROUND

The present invention is related to controlling current to loads, and in particular to a system and method for adaptively controlling current to inductive loads.

Pulse width modulation (PWM) has been used extensively to control power loss in loads. PWM involves controlling current to the load through the use of power switches. The switch is enabled via the PWM signal at a predetermined frequency and duty cycle to control power dissipated in the load. Power supplied to the load is increased by increasing the duty cycle of the PWM signal.

Using fixed frequency PWM to control current creates several drawbacks. Ripple currents are created in the load when current is enabled and disabled to the load. Ripple current is an unwanted alternating-current (AC) error current in the load. The amplitude of the ripple current increases as the frequency of the PWM is reduced.

Electromagnetic interference (EMI) is also generated when switching power on and off to the load. The amount of EMI generated is proportional to the frequency of the PWM. The level of EMI is also affected by the turn-on and turn-off time of the switches. The shorter the turn-on and turn-off time of the switches, the greater the EMI generated.

Power dissipation in the driver circuit is also a concern when switching power on and off to the load. As the PWM frequency is increased, the amount of power dissipation in the driver circuit is increased. This is due to the fact that very little power loss occurs when metal-oxide-semiconductor field-effect transistors (MOSFETs) are in an on or off state, but significant power loss occurs while the MOSFET is operating in the linear region during turn-on or turn-off. It is desirable to provide a current control system that minimizes the power dissipation, EMI generation, and ripple current generated by the driver circuit.

### SUMMARY

A current control system includes a current sensor, a power switch, and a control circuit. The control circuit includes a comparator and a timer circuit. The current sensor senses current supplied to a load. The power switch is controlled to selectively connect power to the load. The comparator compares the sensed current with a commanded current, and the timer circuit ensures the power switch is not enabled more than once within a predetermined time period.

### BRIEF DESCRIPTION OF THE DRAWINGS

FIG. 1 is a block diagram illustrating a system for controlling current to an inductive load according to an embodiment of the present invention.

FIG. 2 is a flowchart illustrating a method for controlling current to an inductive load according to an embodiment of the present invention.

### DETAILED DESCRIPTION

The present invention is related to current control for inductive loads. A current control circuit is used to control a low-side switch in order to control power to an inductive load. The control circuit utilizes a comparator to compare the actual current through the load with a reference voltage indicative of a desired current through the load. If the comparator indicates that the current to the load is greater than the desired current, the low-side switch is turned off. If the comparator indicates that the current to the load is less than the desired current, the low-side switch is turned on to provide power to the load. A timer circuit is utilized to ensure that the low-side switch is not switched on multiple times within a predetermined period of time in order to minimize electromagnetic interference (EMI), ripple current in the load, and power dissipation in the low-side switch. In this way, the current control system can adapt to the needs of any inductive load.

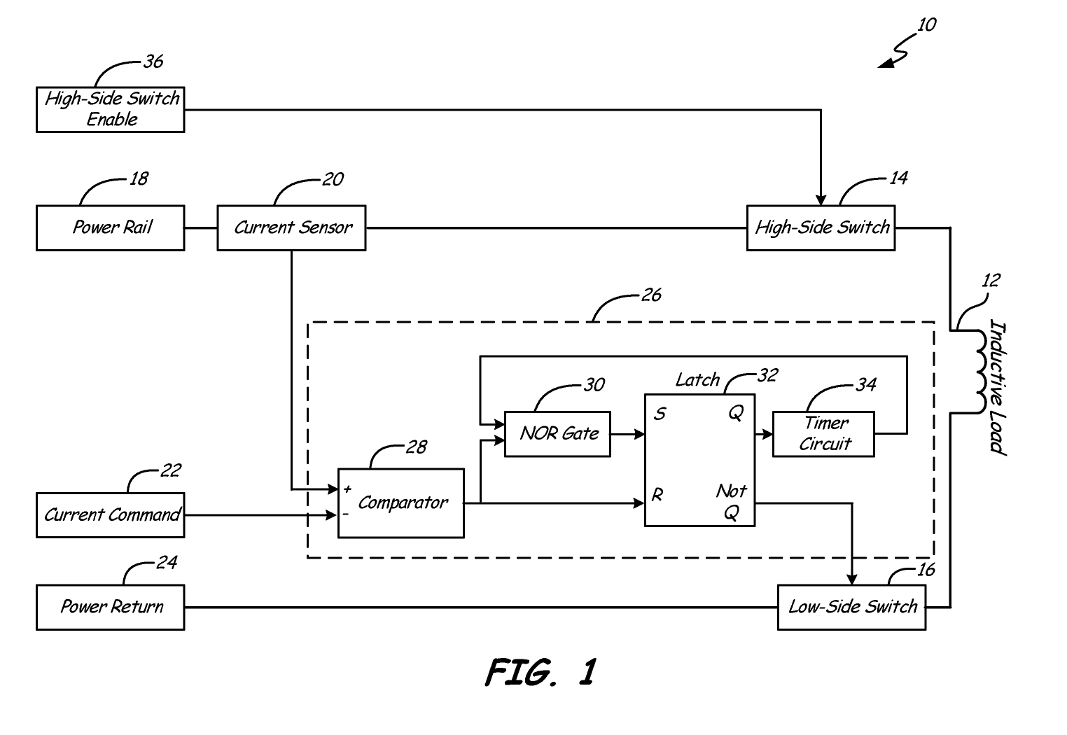

FIG. 1 is a block diagram illustrating system 10 for controlling current to inductive load 12 according to an embodiment of the present invention. System 10 includes high-side switch 14, low-side switch 16, power rail 18, current sensor 20, current command input 22, power return 24, current control circuit 26, and high-side switch enable input 36. Current control circuit 26 comprises comparator 28, NOR gate 30, latch 32, and timer circuit 34. High-side switch 14 and low-side switch 16 are implemented as any type of power switch, such as metal-oxide-semiconductor field-effect transistors (MOSFETs). Current sensor 20 is any device capable of sensing the current to inductive load 12 such as, for example, a shunt resistor.

System 10 is utilized to control the current provided to inductive load 12. Load 12 may be any type of inductive load such as, for example, a solenoid. When both high-side switch 14 and low-side switch 16 are enabled, power is provided to inductive load 12 from power rail 18. Current control circuit 26 controls low-side switch 16. High-side switch 14 is controlled externally by, for example, a microcontroller. During normal system operation, high-side switch 14 remains enabled. Although illustrated with both high-side switch 14 and low-side switch 16, separate embodiments of system 10 may be implemented without the use of high-side switch 14 wherein power is provided to load 12 solely through the use of low-side switch 16.

Comparator 28 is used to compare a sensed current from current sensor 20 with a desired current. The desired current is represented by a voltage from current command input 22. This voltage may be set, for example, by a microcontroller. The sensed current will also be represented by a voltage provided by current sensor 20. The two voltages are provided to comparator 28, which may be implemented by any well known comparator. An output of comparator 28 indicates whether or not the current through inductive load 12 is greater than the desired current. If the monitored current is greater than the desired current, comparator 28 outputs a logic high value voltage. If not, comparator 28 outputs a logic low value voltage. The output of comparator 28 is provided both to latch 32 and NOR gate 30. In the embodiment shown in FIG. 1, latch 32 is implemented as a set-reset (SR) latch and is used to store the state of the output controlling low-side switch 16. The output of comparator 28 is provided to the reset input of latch 32 and the output of NOR gate 30 is provided to the set input of latch 32. In other embodiments, latch 32 may be implemented as any type of latch capable of storing a state of the output controlling low-side switch 16.

Low-side switch 16 is disabled when the monitored current is greater than the desired current. Comparator 28 generates a logic high output that is provided to the reset input of latch 32. Because the output of comparator 28 is a logic high value, the output of NOR gate 30 will be a logic low value, and therefore the voltage provided to the set input of latch 32 will be a logic low value. Given the two inputs, the state of latch 32 will be reset, which will provide an output to disable low-side switch 16 and cut off power to load 12. As illustrated, the inverted output of latch 32 is used to control low-side switch 16. By only disabling power to the load when the monitored current is greater than the desired current, low-side switch 16 can remain enabled when power is initially provided to load 12 to more quickly ramp the current up to an operating level. The power dissipated through load 12 is also reduced from traditional PWM methods by disabling low-side switch 16 immediately after the monitored current becomes greater than the desired current.

Low-side switch 16 is enabled when the current sensed by current sensor 20 is less than the desired current. When the sensed current is less than the desired current, the output of comparator 28 will be a logic low value. When the output of both timer circuit 34 and comparator 28 are at logic low values, the voltage to the set input of latch 32 will be at a logic high value, and the voltage to the reset input of latch 32 will be at a logic low value. This will set the state of latch 32 to a value indicative of enabling low-side switch 16. The output of latch 32 is used to enable low-side switch 16.

Timer circuit 34 is utilized to ensure that low-side switch 16 is not enabled more than one time within a predetermined time period. By preventing low-side switch 16 from being enabled multiple times within a short time period, the EMI generated by system 10 is greatly reduced. The ripple current through load 12 and the power dissipation through low-side switch 16 are also greatly reduced in comparison to traditional PWM methods. The predetermined period of time for timer circuit 34 is any period of time selected to minimize EMI, ripple current, and power dissipation in system 10 such as, for example, approximately 100 microseconds.

Timer circuit 34 is any timer circuit known in the art, such as a monostable 555 timer circuit. Timer circuit 34 is edge triggered and is reset each time low-side switch 16 is enabled. When the timer circuit is reset and begins counting, the output of timer circuit 34 is a logic high value and remains at the logic high value until timer 34 has reached the predetermined time period. This ensures that the output of NOR gate 30 cannot be a logic high value during the predetermined time period and therefore cannot enable low-side switch 16. When timer circuit 34 reaches the end of the predetermined time period, the output of timer circuit 34 transitions to a logic low value and remains at the logic low value until it is reset. This allows low-side switch 16 to be enabled if the monitored current is less than the desired current.

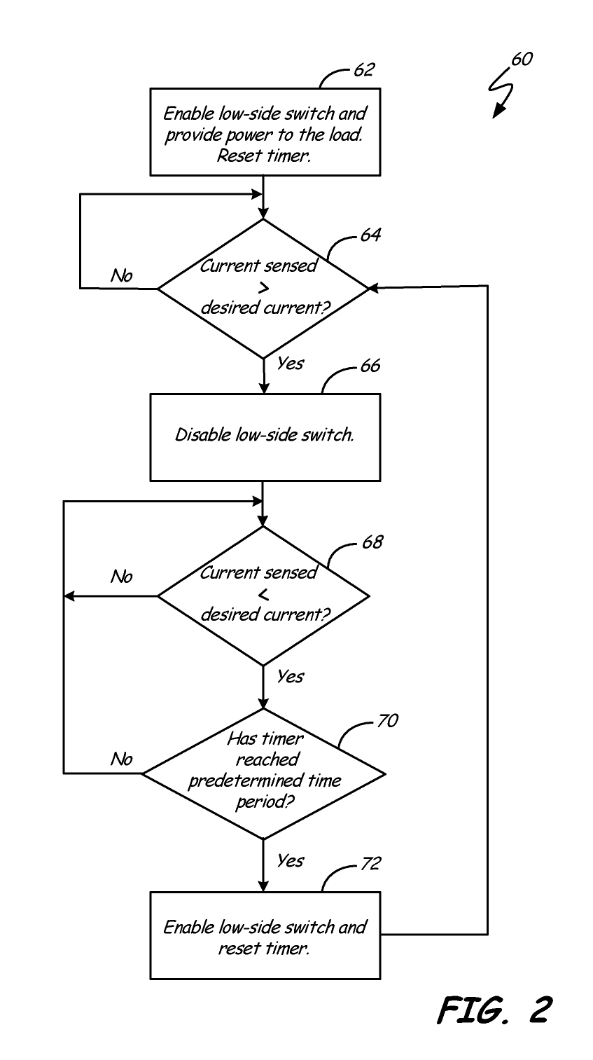

FIG. 2 is a flowchart illustrating a method 60 for controlling current to inductive load 12 according to an embodiment of the present invention. At step 62, power is initially provided to load 12 by enabling low-side switch 16. The current sensed by current sensor 20 will be less than the value indicated by current command input 22. Timer circuit 34 begins counting. At step 64, the monitored current is compared to the desired current using comparator 28. If the monitored current is greater than the desired current, method 60 proceeds to step 66. If the monitored current is less than the desired current, method 60 remains at step 64. At step 66, low-side switch 16 is disabled, cutting off power to load 12. At step 68, the monitored current is compared to the desired current using comparator 28. If the monitored current is less than the desired current, method 60 proceeds to step 70. If the monitored current is greater than the desired current, method 60 remains at step 68. At step 70, it is determined if timer circuit 34 has reached the predetermined time period. If it has, method 60 proceeds to step 72. If it has not, method 60 returns to step 68. At step 72, low-side switch 16 is enabled and timer circuit 34 is reset. Method 60 returns to step 64. Method 60 continues to loop for the duration of normal system operation.

In this way, the present invention describes a system and method for controlling current to an inductive load. Although the present invention has been described with reference to preferred embodiments, workers skilled in the art will recognize that changes may be made in form and detail without departing from the spirit and scope of the invention.

1. A current control system for controlling current provided to a load, the system comprising:
a current sensor that senses a current to the load;
a first power switch selectively enabled to supply power to the load and disabled to prevent power from being supplied to the load; and
a control circuit comprising:
a comparator that compares the sensed current with a commanded current to determine whether to enable or disable the first power switch; and
a timer circuit that prevents the power switch from being enabled by the comparator more than once within a predetermined time period.

2. The system of claim 1, wherein the power switch control circuit further comprises:
a latch that stores the present state of the first power switch, wherein an output of the latch controls the first power switch;
a NOR gate that receives an output of the comparator and an output of the timer circuit, and provides an output to the latch.

3. The system of claim 2, wherein the latch is a set-reset (SR) latch, wherein an output of the comparator is provided to a reset input of the latch, and wherein an output of the NOR gate is provided to a set input of the latch.

4. The system of claim 1, wherein the current sensor is a shunt resistor.

5. The system of claim 1, further comprising a second power switch, wherein both the first power switch and second power switch must be enabled to provide power to the load, and wherein the second power switch remains enabled during normal system operation.

6. The system of claim 1, wherein the predetermined time period is approximately 100 microseconds.

7. A current control method comprising:
sensing a current to a load;
comparing the sensed current with a commanded current;
disabling the power switch to deny power to the load if the sensed current is greater than the commanded current; and
enabling a power switch to provide power to the load if both the sensed current is less than the commanded current and a timer circuit indicates that the power switch has not previously been switched on within a predetermined time period.

8. The method of claim 7, wherein sensing current to a load comprises using a shunt resistor to obtain a voltage indicative of the current to the load.

9. The method of claim 7, wherein the timer circuit is reset and begins counting each time the power switch is switched on.

10. The method of claim 7, wherein the predetermined time is 100 microseconds.

11. A circuit for controlling power to a load comprising:
a sensed current input that receives a sensed current indicative of a current flowing through the load;
a control output that controls a power switch, wherein the power switch is enabled to provide power to the load and disabled to prevent power from being applied to the load;
a comparator that compares the sensed current with a commanded current to determine whether to enable or disable the power switch; and
a timer that prevents the control output from enabling the power switch more than one time within a predetermined time period.

12. The circuit of claim 11, further comprising:
a latch that stores the present state of the control output, wherein outputs of the comparator and timer control the state of the latch, and an output of the latch is provided as the control output.

13. The circuit of claim 12, wherein the latch is a set-reset (SR) latch comprising a set input and a reset input.

14. The circuit of claim 13, wherein the output of the comparator is connected to the reset input of the latch.

15. The circuit of claim 14, further comprising a NOR gate, wherein the output of the comparator and the output of the timer circuit are provided as input to the NOR gate, and wherein the output of the NOR gate is provided to the set input of the latch.

16. The circuit of claim 11, wherein the predetermined time period is 100 microseconds.
